(19) United States
(12) Patent Application Publication
(10) Pub. No.: US 2012/0312901 A1
(43) Pub. Date: Dec. 13, 2012

(54) Extendible or expandable shower device

(75) Inventors: Xinzhan Hu, Xiamen (CN); Shuimin Xu, Xiamen (CN)

(73) Assignee: Ateck (Xiamen) Showers Co., Ltd.

(21) Appl. No.: 13/134,556

(22) Filed: Jun. 10, 2011

(51) Int. Cl. B05B 1/14

(52) U.S. Cl. 239/548

(57) ABSTRACT

A shower device includes a housing having a number of radially extended outlet tubes, and having an inlet mouth for coupling to a water supply pipe, and a number of casings each having a coupling pipe slidably engaged onto the outlet tubes and each having a compartment communicative with the coupling pipe for receiving the water from the outlet tubes, and the casings are movable toward and away from the housing for adjusting or increasing the showering area and for facilitating the showering operation for the user. An actuating device is engaged between the casings and the housing for moving the casings toward and away from the housing.

### BACKGROUND OF THE INVENTION

1. Field of the Invention

The present invention relates to a shower device, and more particularly to an extendible or expandable shower device including an auxiliary showering member movable or extendible relative to a primary showering body for adjusting or increasing the showering area of the shower device and for facilitating the showering operation for the user.

2. Description of the Prior Art

Typical shower devices comprise a housing or receptacle attached or mounted onto a supporting wall or the like fir showering purposes, or further comprise a sprayer member attached or mounted or coupled to a water outlet port that is provided on a supporting wall or the like for receiving the water from the water outlet port and for allowing the water to flow out through the sprayer member.

For example, U.S. Pat. No. 7,657,948 to Tsai discloses one of the typical shower devices comprising a hollow frame having a coupler for engaging with a wall-mounted shower supply pipe and having two tubes attached to two end portions, a housing having a chamber formed by an outer peripheral wall and having two openings for rotatably receiving the tubes, a cover engaged with the housing.

However, normally, the frame and the housing include a predetermined size or dimension or diameter that may not be moved or extended or expanded to a greater area or size or dimension or diameter, such that the showering area of the typical shower devices may not be changed or increased, and the typical shower devices may not be used for suitably showering the users having a greater size or dimension.

The present invention has arisen to mitigate and/or obviate the afore-described disadvantages of the conventional shower faucets or devices.

### SUMMARY OF THE INVENTION

The primary objective of the present invention is to provide a shower device including an auxiliary showering member movable or extendible relative to a primary showering body for adjusting or increasing the showering area of the shower device and for facilitating the showering operation for the user.

In accordance with one aspect of the invention, there is provided a shower device comprising a housing including a number of outlet tubes extended radially and outwardly therefrom, and including an inlet mouth for coupling to a water supply pipe and for receiving a water, and a number of casings each including a coupling pipe extended therefrom and slidably engaged onto the outlet tubes respectively, and each including a compartment formed therein and communicative with the coupling pipe for receiving the water from the outlet tubes, and the casings being movable toward and away from the housing.

An actuating device is further be provided and attached to the housing and engaged between the casings and the housing for selectively moving the casings toward and away from the housing. The casings each include a rack, the actuating device includes a gear rotatably attached to the housing with a pivot axle, and includes a number of pinions rotatably attached to the housing and engaged with the gear and the racks of the casings for allowing the casings to be moved toward and away from the housing with the gear and the pinions.

The gear includes at least one lock notch, and a knob having at least one latch engaged with the lock notch of the gear for attaching the knob to the gear. The gear includes a fence, and a knob having at least one anchor member engaged with the fence of the gear for attaching the knob to the gear.

The casings each include a cap having a number of orifices formed therein. The casings each include a guide plate engaged into the compartment of the casing, and the guide plate includes a number of nozzles extended through the orifices of the casing for guiding the water to flow out through the nozzles of the guide plate.

The housing includes at least one passage formed therein, a board attached to the housing and having a seat and a port engaged with the passage of the housing for receiving the water from the passage of the housing.

A receptacle is further be provided and includes a chamber formed therein and defined by an outer peripheral wall and an upper wall for receiving the housing, and a cover may further be provided and attached to the receptacle for retaining the housing and the board in the receptacle. The cover includes at least one peg extended upwardly therefrom and extended through the board and secured to the housing.

The cover includes a number of perforations formed therein, and a guide plate disposed between the board and the cover and having a number of nozzles extended through the perforations of the cover. The cover includes at least one latch engaged with the port of the board for anchoring the board to the cover. The receptacle includes a number of apertures formed in the outer peripheral wall and aligned with the outlet tubes.

The housing includes a coupler having a sleeve attached to the inlet mouth, and a ball socket pivotally engaged in the sleeve, and the ball socket includes a connecter for coupling to the supply pipe. The housing includes two rings engaged in the sleeve and engaged with the ball socket.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating an operation of a shower device in accordance with the present invention;

FIG. 2 is an upper perspective view of the shower device;

FIG. 3 is a bottom perspective view of the shower device;

FIG. 4 is an exploded view as seen from the upper portion of the shower device;

FIG. 5 is another exploded view as seen from the bottom portion of the shower device;

FIG. 6 is a cross sectional view of the shower device, taken along lines 6-6 of FIG. 3;

FIGS. 7, 8 are cross sectional views of the shower device, taken along lines 7-7, and 8-8 of FIG. 2 respectively;

FIG. 9 is a cross sectional view similar to FIG. 7, illustrating the operation of the shower device;

FIG. 10 is an upper perspective view similar to FIG. 2, illustrating the operation of the shower device; and

FIG. 11 is a cross sectional view similar to FIG. 6, illustrating the operation of the shower device.

### DETAILED DESCRIPTION OF THE PREFERRED EMBODIMENT

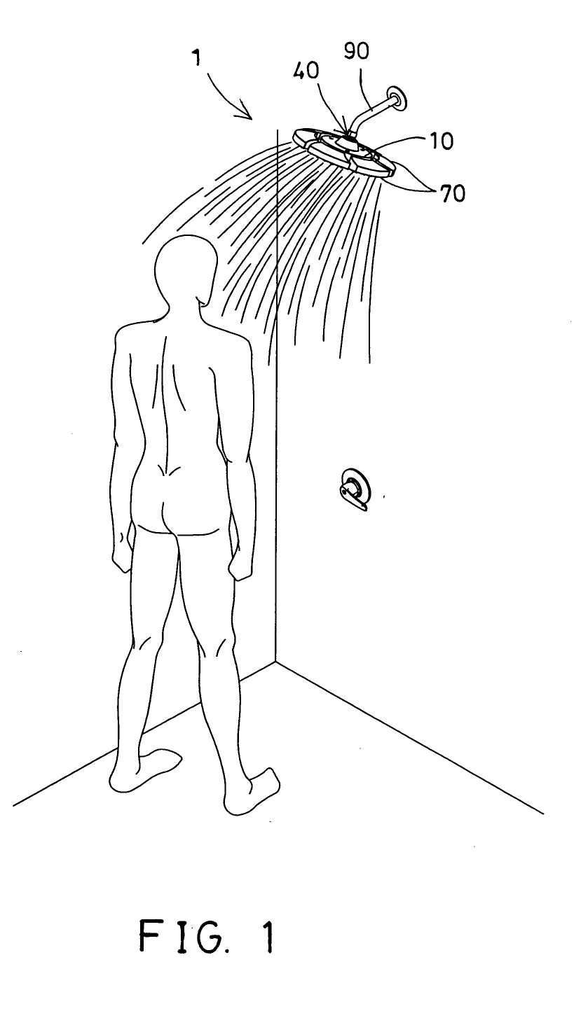

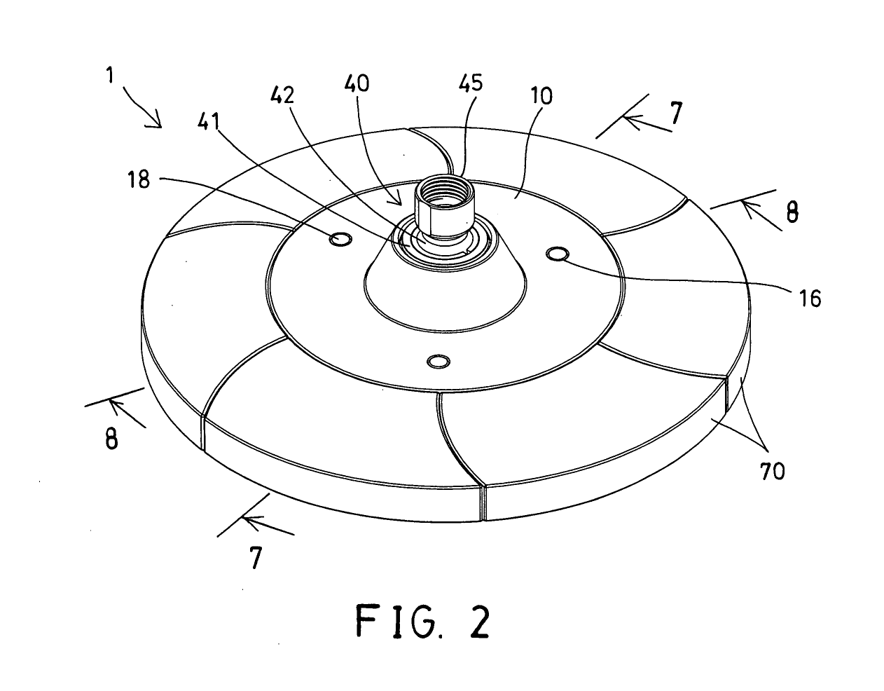

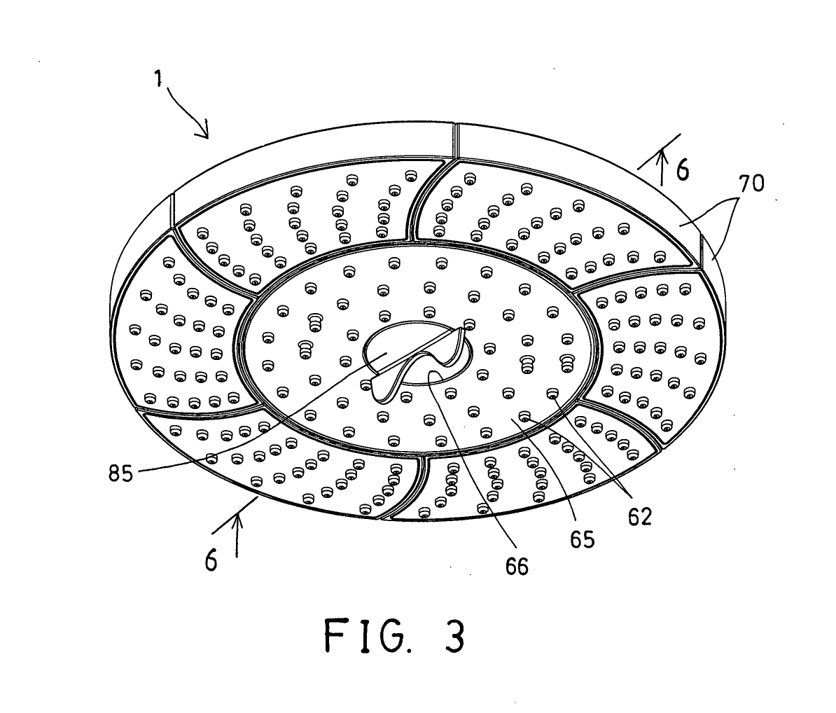

Referring to the drawings, and initially to FIG. 1, a shower device 1 in accordance with the present invention is provided for attaching or mounting or securing or coupling to a wall-mounted shower faucet or shower or water supply pipe 90 for coupling to the water reservoir and for receiving the water from the supply pipe 90 and for allowing the water to selectively flow out through the shower device 1. As shown in FIGS. 2-8, the shower device 1 comprises an outer container or receptacle 10 including a chamber 11 formed therein, and formed or defined by an outer peripheral wall 12 and an upper wall 13, and including a central opening 14 formed in the upper wall 13, and including a number of, such as six apertures 15 formed in the outer peripheral wall 12 and equally spaced from each other.

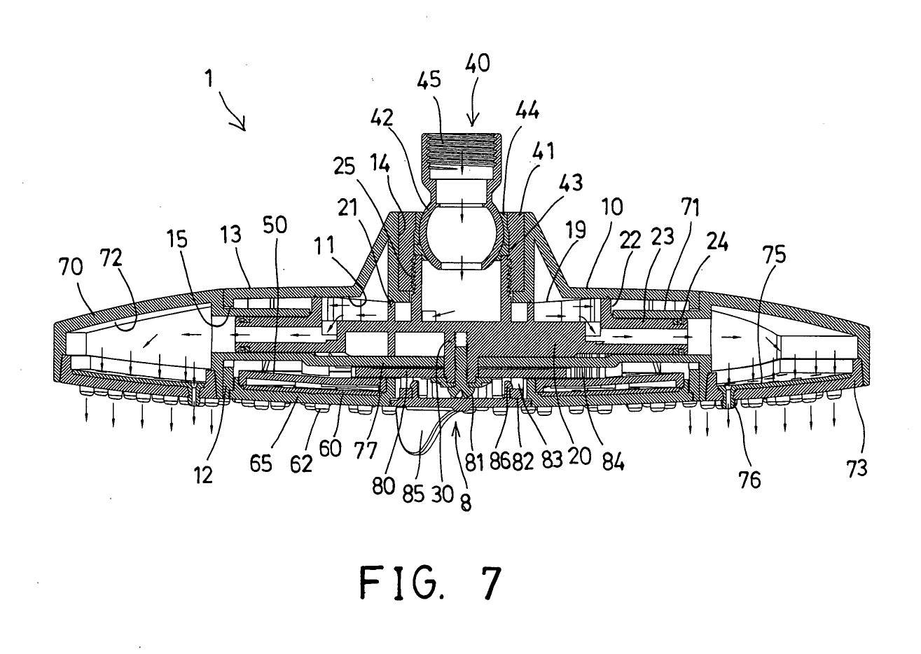

An inner housing 20 is disposed or engaged into the chamber 11 of the receptacle 10 and mounted or secured to the receptacle 10 with one or more (such as three) fasteners 17 which engaged through the holes 16 that are formed in the upper wall 13 (FIGS. 2, 4-5, 8) and secured to the inner housing 20 for forming or defining a space 19 between the receptacle 10 and the housing 20 (FIGS. 7-9). It is preferable that the receptacle 10 includes one or more (such as three) plugs or caps or sealing members 18 engaged into the holes 16 of the receptacle 10 for sealing the holes 16 of the receptacle 10, and for suitably retaining the fasteners 17 in the receptacle 10, and for preventing the dirt or contaminant from flying or entering into the receptacle 10.

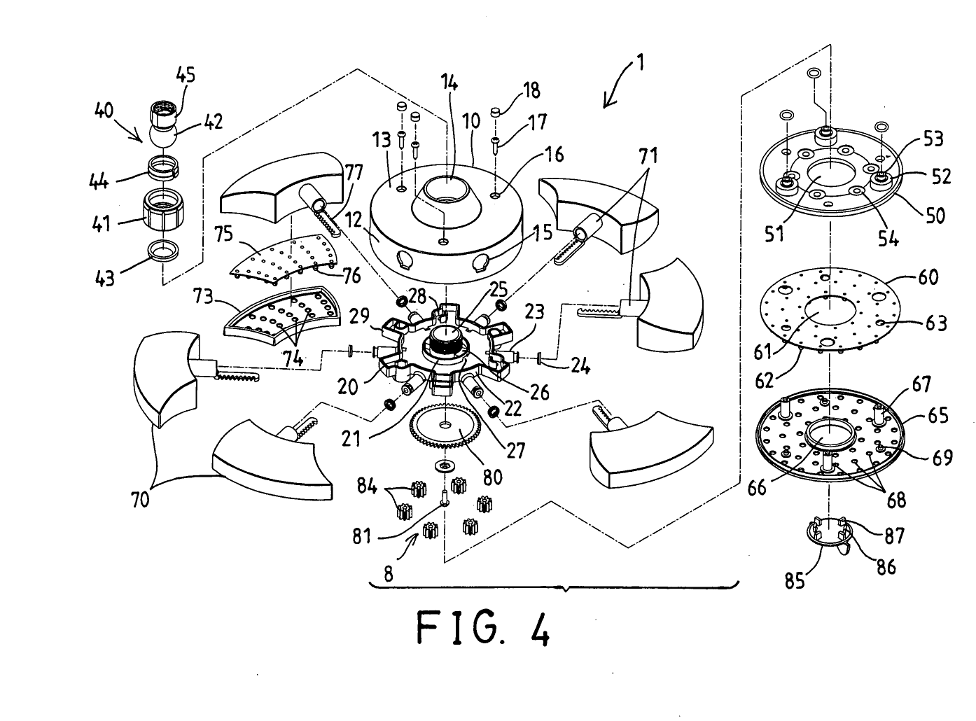

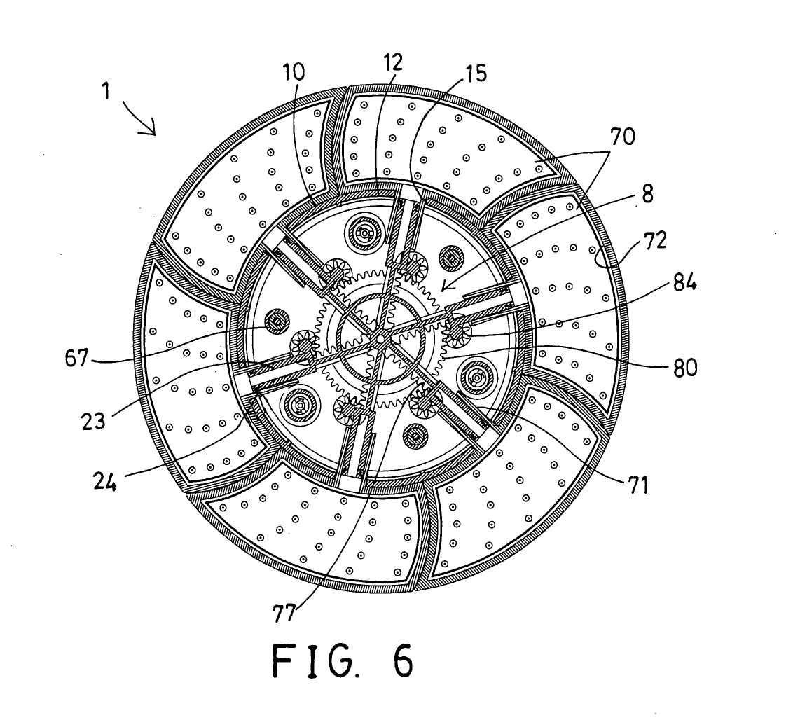

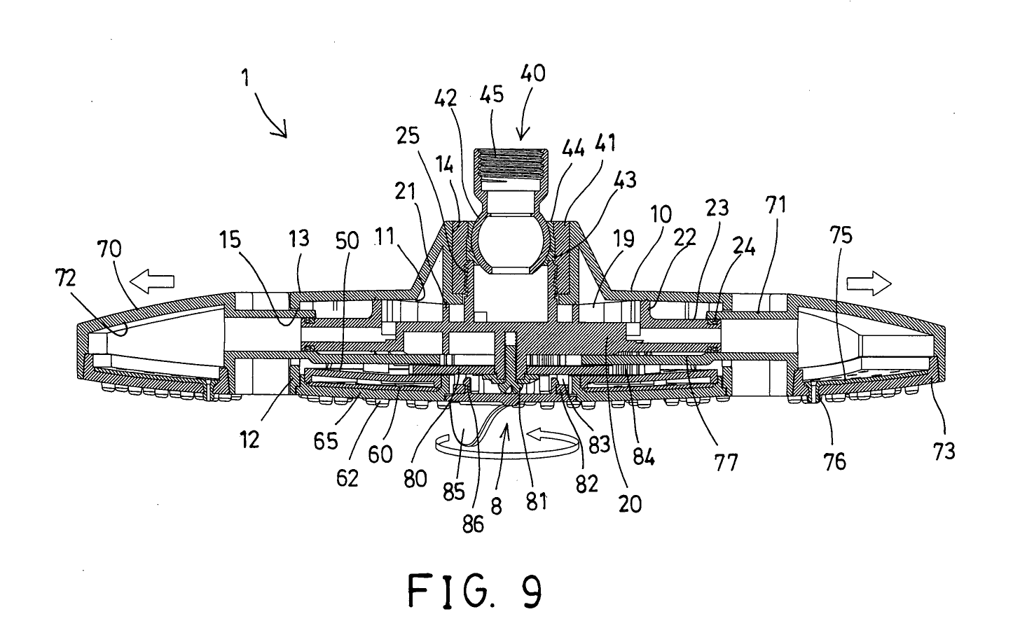

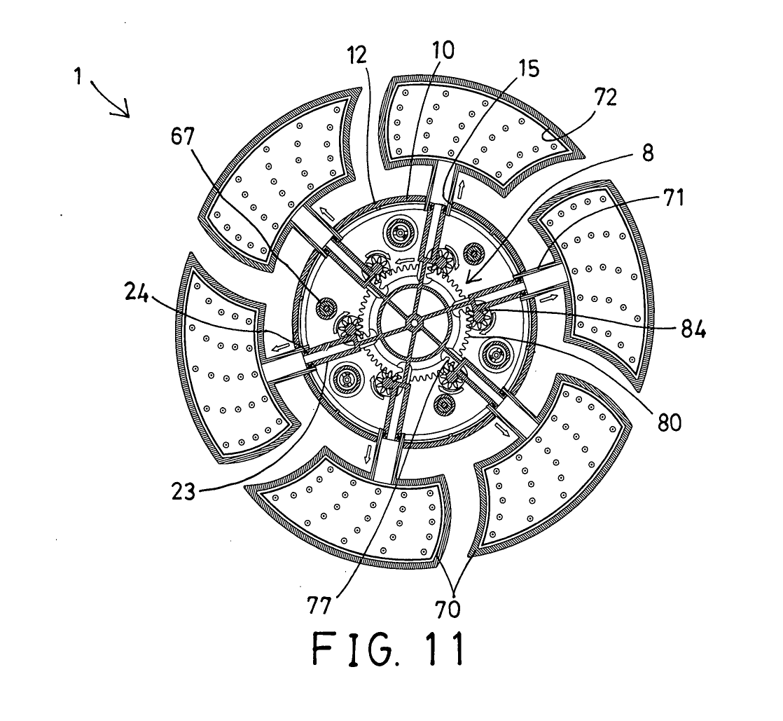

As shown in FIGS. 4-8, the housing 20 includes an inner peripheral fence 21 and an outer peripheral fence 22 for engaging with the receptacle 10 and for forming or defining the space 19 between the inner peripheral fence 21 and the outer peripheral fence 22 of the housing 20 (FIGS. 7, 9), and includes a number of, such as six outlet tubes 23 extended radially and outwardly from the outer peripheral fence 22, and equally spaced from each other, and communicative with the space 19 that is formed or defined between the receptacle 10 and the housing 20, and aligned with or extended or faced or directed toward the apertures 15 that are formed in the outer peripheral wall 12 of the receptacle 10, best shown in FIGS. 6 and 11. It is preferable that a sealing ring 24 is disposed or attached or mounted or secured or engaged onto each of the outlet tubes 23 of the housing 20.

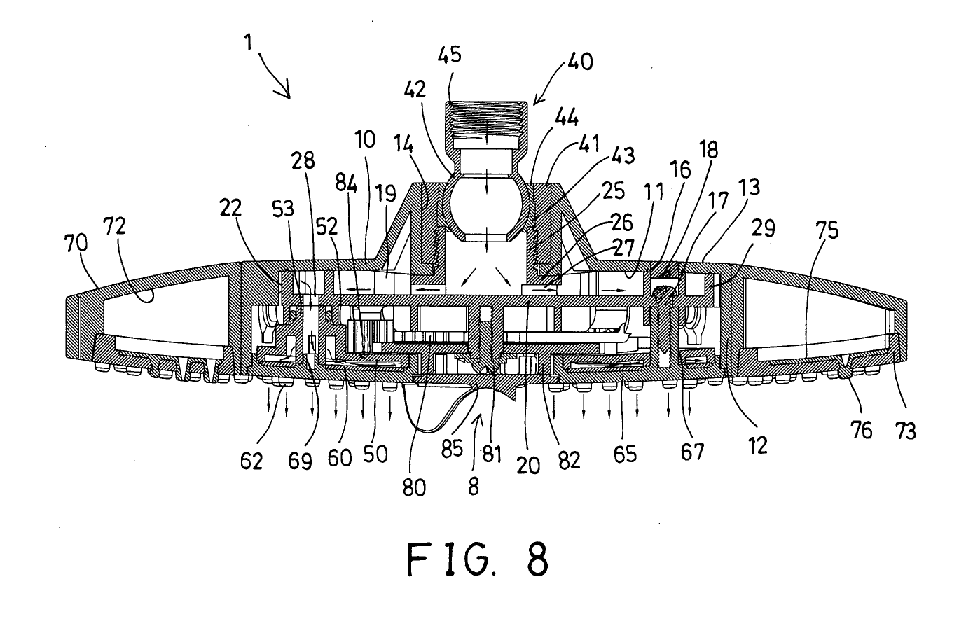

The housing 20 includes an inlet mouth 25 disposed or provided in the inner peripheral fence 21 and spaced from the inner peripheral fence 21, and connected or coupled to the inner peripheral fence 21 or the housing 20 with one or more connecting or coupling ribs 26 for selectively connecting or coupling to the supply pipe 90 with a coupler 40 which will be described or discussed hereinafter, and for receiving the water from the supply pipe 90. The inlet mouth 25 is engaged into the opening 14 of the upper wall 13 of the receptacle 10 and is communicative with the space 19 that is formed between the receptacle 10 and the housing 20 with one or more channels 27 that may be formed in or through the coupling ribs 26 respectively or formed through the inlet mouth 25 or the inner peripheral fence 21 or communicative with the inlet mouth 25 and the space 19 that is formed or defined between the receptacle 10 and the housing 20 (FIGS. 4, 8) for allowing the water to flow from the inlet mouth 25 of the housing 20 into the space 19 that is formed or defined between the receptacle 10 and the housing 20.

The coupler 40 includes a sleeve 41 attached or mounted or threaded or secured to the inlet mouth 25 of the housing 20 and engaged in the opening 14 of the upper wall 13 of the receptacle 10, and a ball socket 42 pivotally or rotatably received or engaged or secured or retained in the sleeve 41 with two gaskets or rings 43, 44, and the ball socket 42 includes a connecter 45 for threading or connecting or coupling to the supply pipe 90 and for guiding the water to flow from the inlet mouth 25 into the space 19 that is formed or defined between the receptacle 10 and the housing 20.

The housing 20 includes one or more (such as three) passages 28 formed therein (FIGS. 4-5, 8), and formed through the housing 20 and communicative with the space 19 that is formed or defined between the receptacle 10 and the housing 20.

A board 50 and a guide plate 60 and a bottom cover 65 are attached or mounted or secured to the bottom portion of the receptacle 10 and/or the housing 20, and each include a central opening 51, 61, 66 formed therein and aligned with each other. The bottom cover 65 includes one or more (such as three) pegs 67 extended upwardly therefrom and extended into or through the board 50 and the guide plate 60 and threaded or engaged with or secured to the housing 20 with the fasteners 17 (FIG. 8), and includes a number of perforations 68 formed therein. The guide plate 60 includes a number of nipples or ports or nozzles 62 extended downwardly therefrom and extended into or through the perforations 68 of the cover 65 for guiding and directing the water to flow out through the nozzles 62 of the plate 60 or the perforations 68 of the cover 65 (FIG. 8).

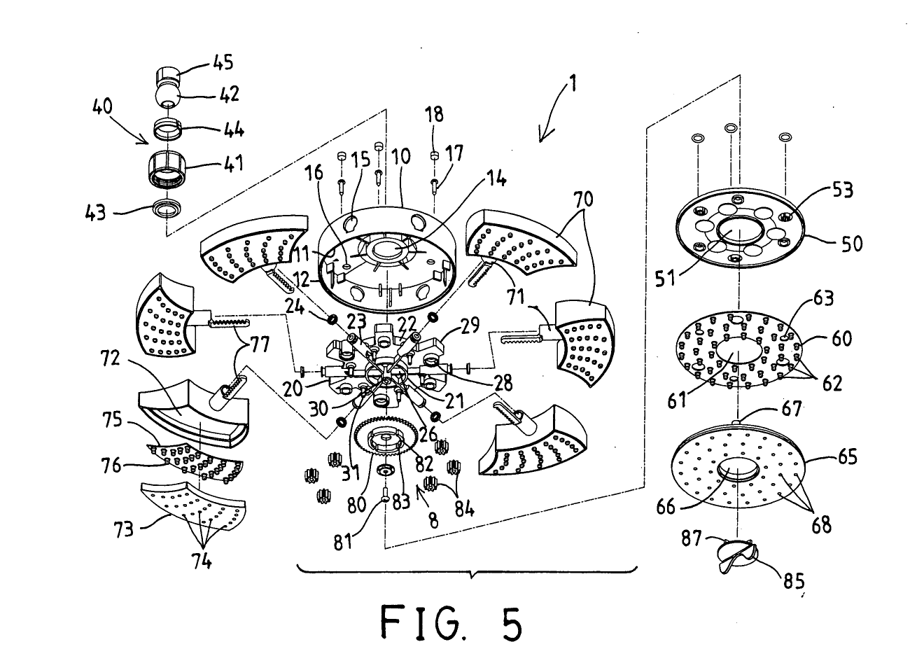

The board 50 includes one or more (such as three) seats 52 extended upwardly therefrom and each having a port 53 extended toward the housing 20 and contacted or engaged with the housing 20, and aligned with or engaged with the passages 28 of the housing 20 (FIG. 8) for allowing the water to selectively flow from the chamber 11 of the receptacle 10 and/or the space 19 that is formed or defined between the receptacle 10 and the housing 20 and/or formed or defined between the inner peripheral fence 21 and the outer peripheral fence 22 of the housing 20, and then to flow through the ports 53 of the seats 52 of the board 50, and then to flow onto the guide plate 60 and then to flow out through the nozzles 62 of the plate 60. The cover 65 further includes one or more (such as three) latches 69 extended upwardly therefrom and extended into or through the holes 63 of the plate 60 (FIGS. 4, 5) and engaged with the ports 53 or the seats 52 (FIG. 8) for solidly and stably anchoring or securing or retaining the board 50 and the plate 60 and the cover 65 together.

As shown in FIGS. 4-5 and 8, the housing 20 may include a number of, such as six protrusions 29 extended radially and outwardly from the outer peripheral fence 22, and equally spaced from each other, and disposed or located between the outlet tubes 23 respectively, and the passages 28 of the housing 20 are located or formed through the protrusions 29 of the housing 20. The housing 20 further includes a stud 30 disposed or provided in the center portion of the inner peripheral fence 21 and connected or coupled or secured to the inner peripheral fence 21 or the housing 20 with the ribs 26 (FIG. 5), and further includes a number of, such as six pins 31 extended downwardly therefrom and equally spaced from each other.

One or more (such as six) auxiliary showering members or casings 70 each include a coupling pipe 71 extended radially and outwardly therefrom and slidably engaged through the apertures 15 of the outer peripheral wall 12 of the receptacle 10, and slidably engaged onto the outlet tubes 23 respectively (FIGS. 6, 7, 9, 11), and each include a compartment 72 formed therein and communicative with the coupling pipe 71 for selectively receiving the water from the outlet tubes 23 (FIG. 7). A cap 73 is attached or mounted or secured to the bottom portion of each of the casings 70 and includes a number of orifices 74 formed therein. A guide plate 75 is disposed or engaged into the compartment 72 of each of the casings 70 and includes a number of nipples or ports or nozzles 76 extended downwardly therefrom and extended into or through the orifices 74 of the casing 70 for guiding and directing the water to flow out through the nozzles 76 of the plate 75 or the orifices 74 of the casing 70 (FIG. 7). The casings 70 each include a rack 77 attached to or extended from the respective coupling pipe 71 or the casing 70.

A moving or actuating device 8 is attached or mounted or secured to the housing 20 and engaged between the casings 70 and the housing 20 for selectively moving the casings 70 toward or away from the housing 20, and includes a gear 80 pivotally or rotatably attached or mounted or secured to the stud 30 or the housing 20 with a pivot axle 81, and includes a peripheral member or fence 82 extended downwardly from the gear 80, and includes one or more lock notches 83 formed in the peripheral fence 82 or in the gear 80, and includes a knob 85 pivotally or rotatably received or engaged in the central openings 51, 61, 66 of the board 50 and the guide plate 60 and the cover 65, and the knob 85 includes one or more latches 86 extended upwardly therefrom and engaged with the lock notches 83 of the peripheral fence 82 or of the gear 80 for attaching or mounting or securing or coupling the knob 85 to the gear 80, and the knob 85 includes one or more anchor members 87 extended upwardly therefrom and engaged with the lock notches 83 or the peripheral fence 82 of the gear 80 for allowing the gear 80 to be pivoted or rotated relative to the housing 20 with or by the knob 85.

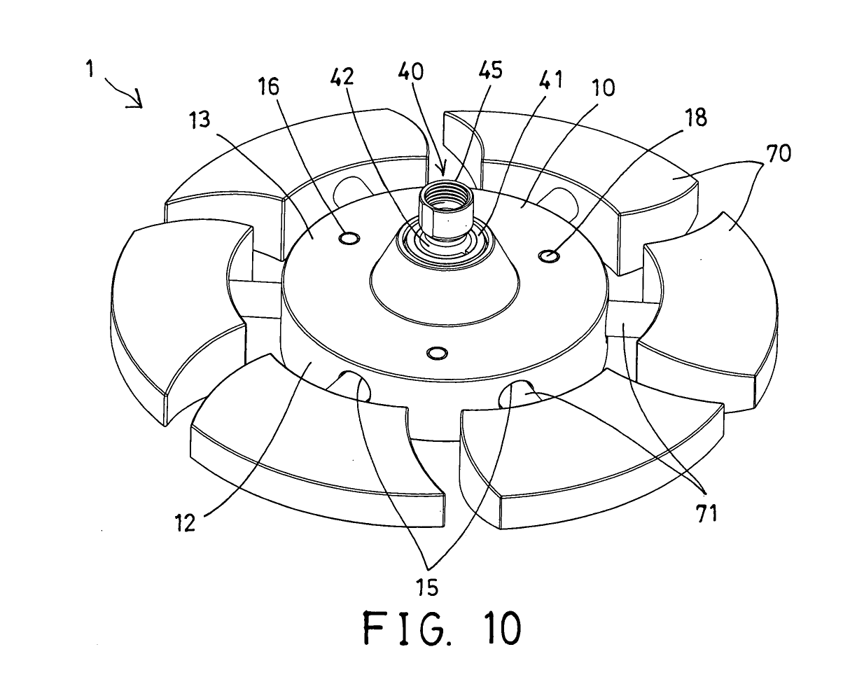

The moving or actuating device 8 further includes a number of, such as six pinions 84 pivotally or rotatably attached or mounted or secured to the housing 20 with the pins 31 and meshed or engaged with the gear 80 and pivotally or rotatably received or engaged in the depressions 54 (FIG. 4) of the board 50, and also meshed or engaged with the racks 77 of the coupling pipes 71 or of the casings 70 for allowing the racks 77 of the coupling pipes 71 or of the casings 70 to be moved toward or away from the housing 20 with the gear 80 and the pinions 84 when the gear 80 is pivoted or rotated relative to the housing 20 with or by the knob 85. In operation, as shown in FIGS. 6, 9-11, the racks 77 of the coupling pipes 71 or of the casings 70 are meshed or engaged with the pinions 84 which are meshed or engaged with the gear 80 for allowing the casings 70 to be moved radially toward or away from or relative to the housing 20 with the gear 80 and the knob 85 and for adjusting the showering area of the shower device 1. It is to be noted that the water may also flow through the outlet tubes 23 and flow into the coupling pipe 71 and then flow into the compartment 72 of the casing 70, and may flow out through the nozzles 76.

Accordingly, the shower device in accordance with the present invention includes one or more auxiliary showering members movable or extendible relative to a primary showering body for adjusting or increasing the showering area and for facilitating the showering operation for the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shower device comprising:
a housing including a plurality of outlet tubes extended radially and outwardly therefrom, and including an inlet mouth for coupling to a water supply pipe and for receiving a water, and
a plurality of casings each including a coupling pipe extended therefrom and slidably engaged onto said outlet tubes respectively, and each including a compartment formed therein and communicative with said coupling pipe for receiving the water from said outlet tubes, and said casings being movable toward and away from said housing.

2. The shower device as claimed in claim 1, wherein an actuating device is attached to said housing and engaged between said casings and said housing for selectively moving said casings toward and away from said housing.

3. The shower device as claimed in claim 2, wherein said casings each include a rack, said actuating device includes a gear rotatably attached to said housing with a pivot axle, and includes a plurality of pinions rotatably attached to said housing and engaged with said gear and said racks of said casings for allowing said casings to be moved toward and away from said housing with said gear and said pinions.

4. The shower device as claimed in claim 3, wherein said gear includes at least one lock notch, and a knob having at least one latch engaged with said at least one lock notch of said gear for attaching said knob to said gear.

5. The shower device as claimed in claim 3, wherein said gear includes a fence, and a knob having at least one anchor member engaged with said fence of said gear for attaching said knob to said gear.

6. The shower device as claimed in claim 1, wherein said casings each include a cap having a plurality of orifices formed therein.

7. The shower device as claimed in claim 6, wherein said casings each include a guide plate engaged into said compartment of said casing, and said guide plate includes a plurality of nozzles extended through said orifices of said casing for guiding the water to flow out through said nozzles of said guide plate.

8. The shower device as claimed in claim 1, wherein said housing includes at least one passage formed therein, a board attached to said housing and having a seat and a port engaged with said passage of said housing for receiving the water from said passage of said housing.

9. The shower device as claimed in claim 8 further comprising a receptacle including a chamber formed therein and defined by an outer peripheral wall and an upper wall for receiving said housing, and a cover attached to said receptacle for retaining said housing and said board in said receptacle.

10. The shower device as claimed in claim 9, wherein said cover includes at least one peg extended upwardly therefrom and extended through said board and secured to said housing.

11. The shower device as claimed in claim 9, wherein said cover includes a plurality of perforations formed therein, and a guide plate disposed between said board and said cover and having a plurality of nozzles extended through said perforations of said cover.

12. The shower device as claimed in claim 9, wherein said cover includes at least one latch engaged with said port of said board for anchoring said board to said cover.

13. The shower device as claimed in claim 9, wherein said receptacle includes a plurality of apertures formed in the outer peripheral wall and aligned with said outlet tubes.

14. The shower device as claimed in claim 1, wherein said housing includes a coupler having a sleeve attached to said inlet mouth, and a ball socket pivotally engaged in said sleeve, and said ball socket includes a connecter for coupling to said supply pipe.

15. The shower device as claimed in claim 14, wherein said housing includes two rings engaged in said sleeve and engaged with said ball socket.
